(19) United States
(12) Patent Application Publication
(10) Pub. No.: US 2003/0052231 A1
(43) Pub. Date: Mar. 20, 2003

(54) Modular RTM spacecraft bus structure

(76) Inventors: Brian K. Moon, Santa Clarita, CA (US); Don H. Matsumoto, Pasadena, CA (US); Tim E. Taylor, Moorpark, CA (US)

Correspondence Address: PATENT COUNSEL, TRW INC., S & E LAW DEPT., ONE SPACE PARK, BLDG. E2/6051, REDONDO BEACH, CA, 90278, US

(21) Appl. No.: 09/957,393

(22) Filed: Sep. 19, 2001

(51) Int. Cl. B64G 1/22; B64G 1/00

(52) U.S. Cl. 244/158 R

(57) ABSTRACT

A spacecraft bus (30) that is assembled from piece parts (10) made by a resin transfer molding process. The resin transfer molding process includes forming graphite sheets in a mold prior to injecting a resin into the mold. Because the spacecraft bus (30) is an assembly of piece parts (10) made by a resin transfer molding process, the piece parts (10) can be made very large and complex.

### BACKGROUND OF THE INVENTION

1. Field of the Invention

This invention relates generally to a spacecraft bus and, more particularly, to a modular spacecraft bus that includes only a few assembled piece parts, where the piece parts are made by a resin transfer molding process.

2. Discussion of the Related Art

Spacecraft and satellites include a structural housing or spacecraft bus that makes up the support structure of the spacecraft to support the various spacecraft systems, and provide integrity for spacecraft launch and flight. The current spacecraft bus is an assembly of many hundreds of piece parts that are connected together by bolts, epoxy or the like to provide the finished spacecraft bus assembly. Typically, such an assembly process requires many thousands of man hours to perform the process, sometimes taking two or more years to complete. Thus, the labor alone necessary to assemble a spacecraft bus is extremely costly. Further, the assembly of a spacecraft bus has considerable scheduling requirements.

As is known, a conventional spacecraft bus is made of graphite piece parts, including graphite fibers bonded together with a resin bonding material in a “prepreg” process. Each separate piece part that is part of the spacecraft bus assembly is made by forming a series of thin sheets of the graphite fiber and resin material around a mold or mandrel. Pressure is applied to the sheets formed on the mold so that they conform to the mold shape. The mold is then placed in an oven that causes the resin to liquefy and cure to form the solid piece part. Once the piece is cured and cooled, it is then assembled with the other piece parts formed in the same way to provide the assembled spacecraft bus.

The prepreg process discussed above is generally not suitable to form large and/or structurally complex pieces. This is because the individual sheets of graphite fiber impregnated resin are hard to bend and sticky, requiring significant difficulty and labor intensive processes to be positioned in the mold. Because of at least this disadvantage, the size and complexity of the parts that form the spacecraft bus assembly is severely limited.

Resin transfer molding (RTM) is a known process by which certain structural parts are made. In the RTM process, sheets of graphite, or other materials, are formed around a mold or mandrel and are conformed thereto by pressure. Once the layers are formed in the mold, a resin is then injected into the mold to bind the sheets together. The initial sheets of graphite do not include the resin binder, and thus are dry and more readily pliable than the graphite sheets used in the prepreg process. The mold is then heated to allow the resin to cure. Because the sheets of graphite used in the RTM process are dry and flexible, it takes less manpower to form the layers to the mold, and thus larger and more complex parts can be made.

### SUMMARY OF THE INVENTION

In accordance with the teachings of the present invention, a modular spacecraft bus is disclosed that is assembled from piece parts made by a resin transfer molding (RTM) process. Because the piece parts are made by the RTM process, they can be made significantly larger and more complex than those previously known in the art, and thus the spacecraft bus is an assembly of much fewer parts, reducing labor costs. In one embodiment, the number of spacecraft bus parts made by the RTM process is one for every 100 parts made by the known prepreg techniques.

Additional objects, advantages and features of the present invention will become apparent from the following description and appended claims, taken in conjunction with the accompanying drawings.

### BRIEF DESCRIPTION OF THE DRAWINGS

FIGS. 1(a) and 1(b) are opposite end perspective views of a single molded piece part for a modular spacecraft bus, where the piece part is made by a resin transfer molding process, according to the invention;

FIG. 2 is an end perspective view of the modular spacecraft bus piece part shown in FIGS. 1(a) and 1(b) that has been machined for receiving spacecraft system panels;

FIG. 3 is an end perspective view of a spacecraft bus made of three interconnected modular piece parts of the type shown in FIG. 2;

FIGS. 4-6 show three perspective, cross-sectional views of a spacecraft launch fairing including one, two and three assembled spacecraft buses, respectively, mounted therein, where each spacecraft bus is an assembly of piece parts made by a resin transfer molding process of the invention; and

FIG. 7 is an exploded perspective view of another modular spacecraft bus made by piece parts fabricated by a resin transfer molding process, according to the invention.

### DETAILED DESCRIPTION OF THE EMBODIMENTS

The following discussion of the embodiments of the invention directed to a modular spacecraft bus made from an assembly of only a few piece parts, where the piece parts are manufactured by a resin transfer molding process, is merely exemplary in nature, and is in no way intended to limit the invention or its application or uses.

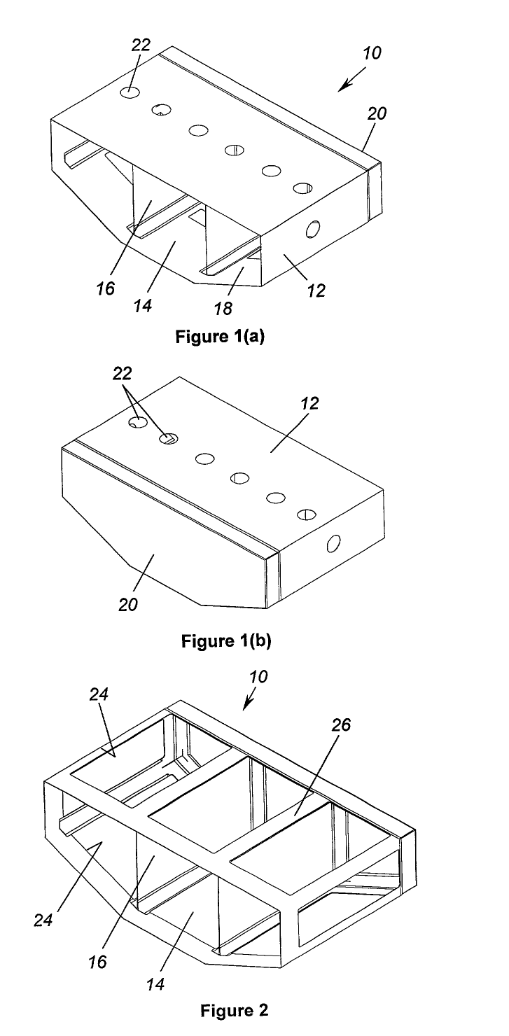

FIGS. 1(a) and 1(b) show opposite end views of a piece part unit 10 that is part of a spacecraft bus assembly. According to the invention, the unit 10 is a modular piece part molded by an RTM process to form a single molded piece. The unit 10 is a trapezoidal, semi-monocoque module that includes an external wall 12 formed in a hexagonal shape, as shown, and defining a chamber 14 therein. A series of internal spacer walls 16 are formed as part of the unit 10 that separate the chamber 14 into sub-chambers 18. The unit 10 includes an end section 20 that closes off the chamber 14 at one end of the unit 10. A series of holes 22 are formed in a line in the wall 12, as shown, to accommodate the tooling used in the RTM mold. As shown herein, the size, shape, wall thickness, etc. of the unit 10 is for a particular resin transfer mold. Other RTM molds will form piece part units of different shapes for other spacecraft buses. In this example, the unit 10 is about 9 feet by 5 feet by 4 feet.

As mentioned above, the unit 10 is made by a resin transfer molding (RTM) process of the type known in the art, and generally described above. Because the unit 10 is made by the RTM process, it can be made larger and more complex, and thus the number of piece parts needed to assemble a complete spacecraft bus can be reduced over known fabrication techniques. According to one embodiment of the present invention, the piece part ratio between the necessary piece parts made by known techniques and the representative modular piece parts made by the RTM process of the invention is about 100 to 1 in that each separate unit of the invention replaces 100 piece parts in the known designs.

After the unit 10 is removed from the RTM mold, it is then trimmed to length and machined to remove sections of the wall 12 to accommodate the various spacecraft sub-systems and panels. FIG. 2 shows a perspective view of the unit 10 where the wall 12 has been machined to form openings 24 therein. In this example, the end section 20 has been trimmed away. Panels (not shown) are attached to wall sections 26 forming the remaining structure of the wall 12, and the various spacecraft sub-systems are mounted within the sub-chambers 18 of the chamber 14. The various spacecraft sub-systems mounted within the sub-chambers 18 include attitude control sub-systems, data management sub-systems, electrical power sub-systems, etc. The panels would be mounted to the wall sections 26 by any suitable technique, such as bolts, epoxy, or the like.

FIG. 3 shows a perspective view of a spacecraft bus 30 that is an assembly of three of the units 10. A spacecraft bus of the same type as the spacecraft bus 30 but made by known techniques would include about 300 piece parts. Because each unit 10 replaces about 100 separate piece parts in the known designs, the spacecraft bus 30 only includes three separate piece parts. The RTM mold makes the unit 10 a predetermined maximum size. The unit 10 is trimmed and cut to size to make the bus 30. The length of each separate unit 10 is trimmed so that the overall length of the bus 30 is the desired length. This can be provided by trimming the various units 10 to a desired length where all the units 10 are of the same length or different lengths. The units 10 are bonded together by any suitable technique, such as bolts, epoxy, or the like.

According to the invention, variations of known RTM processes can be used to make the units 10. One suitable RTM process is used by GKN Aerospace. Another RTM process that can be used in connection with the invention is a vacuum assist RTM process that employs vacuum and air pressure to form the graphite fiber sheets before the resin is injected into the mold. This method is useful for very large structures, but typically produces parts with non-uniform and non-repeatable thicknesses, and thus may not always be suitable for spacecraft bus piece parts. Another RTM process useable for the present invention employs solid metal tooling to form composite parts prior to resin injection.

The spacecraft bus 30 discussed herein is designed to be entirely modular. This allows parallel assembly and integration of the spacecraft bus 30. The mold used in the RTM process is designed so that a single piece can be trimmed to provide various size modules for different size spacecraft buses. The spacecraft bus design is unique because several of the singular design elements are merged together into the design and fabrication methodologies. The design and analysis of the spacecraft bus structure is greatly simplified due to the elimination of numerous joints encountered with standard or known piece-part designs. This is accomplished by consolidating entire frame sections into a single-step transfer of resin into a closed RTM mold. In this way, both the internal and external dimensions may be maintained at the necessary tolerances, eliminating the need for shimming, complicated assembly tooling and alignments. Weight predictions for composite systems fabricated in this manner are more reliable due to the metering of the amount of resin injected into the tool, as well as from the elimination of the bleeder system employed by more conventional composite fabrication techniques.

The problem of thermal distortion in the space environment is greatly reduced or eliminated when the spacecraft bus is fabricated by the RTM process with the same material throughout. This includes the elimination of the bonding materials currently utilized and standard piece-part graphite structures. The RTM process for structural components can accommodate a large variety of materials ranging from low to high strength, low to high stiffness and low to high conductivity fibers or a mixture of fibers. The resins can also be changed without perfecting the tooling. This gives the designer the ability to tailor the properties to meet program technical and cost requirements.

Grounding, shielding, EMR foils or debris screens can be co-cured into the RTM process, thus eliminating the cost and schedule increases associated with secondary bonding. In addition, traditional spacecraft buses have been point designs to meet a specific program requirement set, or in the case of an existing common bus, no flexibility exists for sizing. With the design proposed by the present invention, a host of programs can be accommodated by varying the number and length of the units 10. Additional flexibility can be achieved by adjusting the tooling to vary the width and height of the modules.

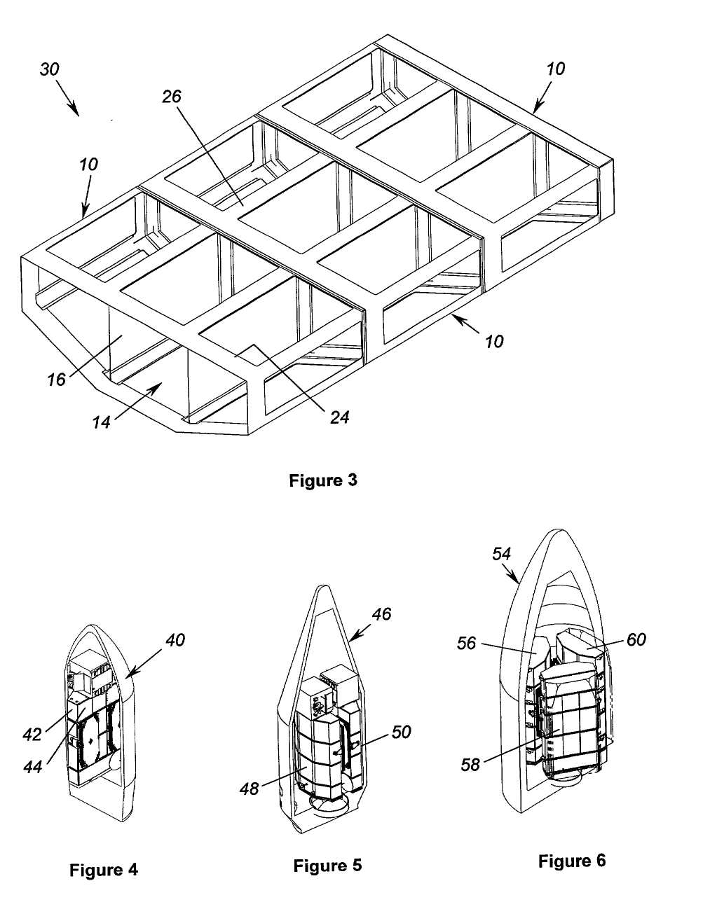

FIG. 4 shows a half-shell of a launch vehicle fairing 40 including a spacecraft bus 42 mounted therein, where the bus 42 is made by the RTM process of the invention. In this view, the bus 42 is shown with spacecraft sub-system panels 44 mounted thereto. In alternate designs, and due to the modular nature of the spacecraft bus 30, multiple spacecrafts can be launched in a single launch vehicle fairing to reduce launch costs and other associated costs. FIG. 5 shows a launch vehicle fairing 46 including two separate spacecraft buses 48 and 50 are mounted therein, where both buses 48 and 50 are assembled by only a few piece parts, according to the invention discussed herein. FIG. 6 shows yet another launch vehicle fairing 54 in which three separate modular spacecraft buses 56, 58 and 60 are mounted therein, where the spacecraft buses 56, 58 and 60 are assembled by an RTM process discussed herein.

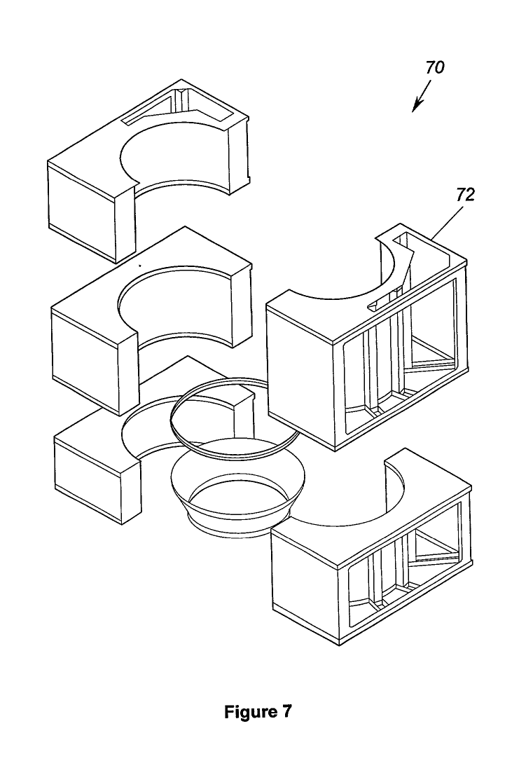

FIG. 3 shows the spacecraft bus 30 to be a particular size and shape. However, the RTM process of the present invention can make virtually any shaped bus spacecraft. FIG. 7 is an exploded, perspective view of another spacecraft bus 70 that employs only a few modular piece part units 72. As above, each of the piece parts units 72 are made by an RTM process so that they are made larger and more complex than those that could have been prior in the industry. In this example, the units 72 are square structures for a different spacecraft design.

The foregoing discussion discloses and describes merely exemplary embodiments of the present invention. One skilled in the art will readily recognize from such discussion and from the accompanying drawings and claims, that various changes, modifications and variations can be made therein without departing from the spirit and scope of the invention as defined in the following claims.

What is claimed is:

1. A spacecraft bus assembled by a plurality of spacecraft bus piece parts coupled together, each of the spacecraft bus piece parts being made by a resin transfer molding (RTM) process.

2. The spacecraft bus according to claim 1 wherein the spacecraft bus piece parts are made of graphite sheets bonded together with a resin.

3. The spacecraft bus according to claim 1 wherein the plurality of piece parts are coupled together by bolts or glue.

4. The spacecraft bus according to claim 1 wherein the resin transfer molding process is a vacuum assist resin transfer molding process.

5. The spacecraft bus according to claim 1 wherein the RTM piece parts are more than five feet in length.

6. The spacecraft bus according to claim 5 wherein a plurality of the piece parts are about nine feet in length and five feet in width.

7. The spacecraft bus according to claim 1 wherein the plurality of spacecraft bus piece parts are modular parts including an external wall and internal walls defining internal chambers therein.

8. The spacecraft bus according to claim 7 wherein the piece parts include openings in the external wall to accommodate spacecraft sub-system panels.

9. The spacecraft bus according to claim 1 wherein several of the plurality of spacecraft bus piece parts have the same general shape.

10. The spacecraft bus according to claim 9 wherein the piece part shape is a trapezoidal, semi-monocoque shape.

11. The spacecraft bus according to claim 9 wherein the piece part shape is a general square shape.

12. A modular spacecraft bus comprising an assembly of spacecraft bus piece parts coupled together, a plurality of the spacecraft bus piece parts being made by a resin transfer molding (RTM) process including molding graphite sheets bonded together with a resin, each RTM piece part including an external wall and internal walls defining internal chambers therein, wherein the external wall includes openings to accommodate spacecraft sub-system panels.

13. The spacecraft bus according to claim 12 wherein the resin transfer molding process is a vacuum assist resin transfer molding process.

14. The spacecraft bus according to claim 12 wherein the RTM piece parts have a trapezoidal, semi-monocoque shape.

15. The spacecraft bus according to claim 12 wherein the RTM piece parts have a general square shape.

16. The spacecraft bus according to claim 12 wherein the RTM piece parts are more than five feet in length.

17. A method of making a spacecraft bus comprising:
making a plurality of spacecraft bus piece parts by a resin transfer molding process; and
assembling the piece parts together to form the spacecraft bus.

18. The method according to claim 17 wherein the step of making the piece parts includes forming a plurality of graphite sheets into a mold prior to injecting a resin into the mold.

19. The method according to claim 17 wherein making the piece parts includes making the piece parts by a vacuum assist resin transfer molding process.

20. The method according to claim 17 wherein each piece part is more than five feet in length.
